(19) United States
(12) Patent Application Publication
(10) Pub. No.: US 2001/0046826 A1
(43) Pub. Date: Nov. 29, 2001

(54) Textile material and a process for manufacturing such a textile material

(76) Inventor: Gerold Tebbe, Monte Carlo (MC)

Correspondence Address: FACTOR & PARTNERS, LLC, 1327 W. WASHINGTON BLVD., SUITE 5G/H, CHICAGO, IL, 60607, US

(21) Appl. No.: 09/844,415

(22) Filed: Apr. 27, 2001

(30) Foreign Application Priority Data
Apr. 29, 2000 (DE) 10021000-7
May 13, 2000 (DE) 10023629.4

(51) Int. Cl. D03D 15/00; B32B 27/12; B32B 5/16

(52) U.S. Cl. 442/294; 442/181; 442/286

(57) ABSTRACT

A textile material has a base structure (10) and a functional layer (18) supported by this latter. This functional layer comprises material (22) which glides over the skin with a low degree of friction.

The invention relates to a textile material according to the precharacterising clause of claim 1, and to a process for manufacturing such a textile material.

Materials which are used to manufacture items of clothing such as trousers, shirts, blouses, underwear and the like, and which come into direct contact with a wearer's skin are occasionally felt by the wearers to be uncomfortable. They scratch or irritate the skin. It would therefore be desirable if such materials could be modified so that they feel more pleasant against the skin. Conversely, with such a possibility for modification at one's disposal, it would also be possible to consider making items of clothing out of materials which one would previously not think of wearing directly against the skin, which may be of interest both in terms of the technical advantages and in terms of the aesthetic advantages.

The object of the present invention, therefore, is to produce a textile material which can be made more comfortable for the wearer in simple manner.

This object is achieved according to the invention by a textile material according to claim 1.

In this, the base structure, which can be composed of fibres but which can also be a film, is furthermore appropriate for the basic mechanical properties of the textile material, whilst the functional layer, which is applied to at least one side of the base structure, ensures the wearability properties.

Advantageous further developments of the invention are described in the subclaims.

The further development of the invention according to claim 2 is advantageous in terms of the economical use of the material out of which the functional layer is made. Also, the basic properties of the base structure are maintained in the regions between the areas of the functional layer. Thus, it would be conceivable for a particular functional layer, which for example ensures that the textile material glides easily over the skin or that it has a pleasant feel, to be less advantageous with respect to its moisture permeability. However, in such a case, the moisture permeability of the textile material is on the whole retained, since uncoated regions remain between the sub-regions of the functional layer.

As a result of the further development of the invention according to claim 3, the functional layer and unaltered sub-regions of the base structure alternate at very small spacings. However, the direct contact between the wearer's skin and the textile material takes place predominantly by way of the free surfaces of the particles of the functional layer.

The further development of the invention according to claim 4 is then particularly advantageous if deterioration of the functional layer is to be expected during use of the textile material.

The further development of the invention according to claim 5 enables the wearer's skin to be influenced specifically when the textile material is worn. The active substances provided in the particles can include those which have a physical action or those which have a chemical or medicated action. Examples of active substances which work physically are in particular substances which can absorb moisture, in particular perspiration, or those which modify the “feel” of the textile material, or those which help the textile material to glide over the skin with a low degree of friction. Further active substances can include fragrances or deodorants or the like. Again, further medicated active substances can include substances which prevent or reduce perspiration, which supply care agents to the skin, for example vitamins, which contain active substances which may be supplied via the skin, or even those which counteract or prevent fungal infections of the skin.

The further development of the invention according to claim 6 is advantageous in terms of the active substances being released onto the skin on direct contact.

The further development of the invention according to claim 7 is advantageous in terms of the saving on material and in terms of the elasticity of the particles.

The further development of the invention according to claim 8 ensures a slow release of the active substances.

As a result of the further development of the invention according to claim 9, the basic geometry of the base structure is modified only slightly by the functional layer. Moreover, proven processes are available for the manufacture of microcapsules.

The further developments of the invention according to claims 10 to 13 are advantageous in terms of controlling the release of the active substances.

Claims 14 and 15 describe alternative possibilities for connecting the particles to the base structure of the textile material.

Also as a result of the further development of the invention according to claim 16, the contact between the textile material and a wearer's skin is effected at least predominantly by way of the functional layer, whilst a large part of the base structure of the textile material remains unaltered.

Textile materials according to claim 17 are notable for gliding easily over the skin and are therefore particularly suitable for trousers, shirts, blouses, underwear and the like.

The materials described in claim 18 are stable under wearing conditions and under washing conditions and are notable for being comfortable for the wearer. This is particularly true of ceramics particles, since these have a cooling sensation.

Claim 19 indicates preferred diameters for particles contained in the functional layer.

The further development of the invention according to claim 20 enables items of clothing to first of all be provided with a protective layer which comes into contact with the skin of different customers trying on the items of clothing, but can be removed easily by the buyer after an item of clothing has been purchased.

The process according to claim 21 enables the base structure to be provided simply and economically with a defined functional layer having a uniform thickness.

According to claim 22, it is also possible to impregnate the base structure more deeply with the material of the functional layer.

The process according to claim 23 is advantageous in terms of an even deeper impregnation of the base structure with the material of the functional layer. Also, the use of a compliant circumferential layer of the application roller is particularly suitable if the material of the functional layer, which is applied in liquid form, contains admixed particles, in particular admixed microcapsules.

The further development of the invention according to claim 24 enables only predetermined sub-regions of the surface of a base structure to be covered with functional-layer material, so that the functional layer comprises spaced patches of material.

The further development of the invention according to claim 25 is advantageous if the particles of the functional layer are particularly fine and/or particularly fragile, for example microcapsules.

The process according to claim 26 can be carried out in particularly simple manner using spray devices.

The invention is explained in more detail below, with the aid of exemplary embodiments and with reference to the drawing, in which:

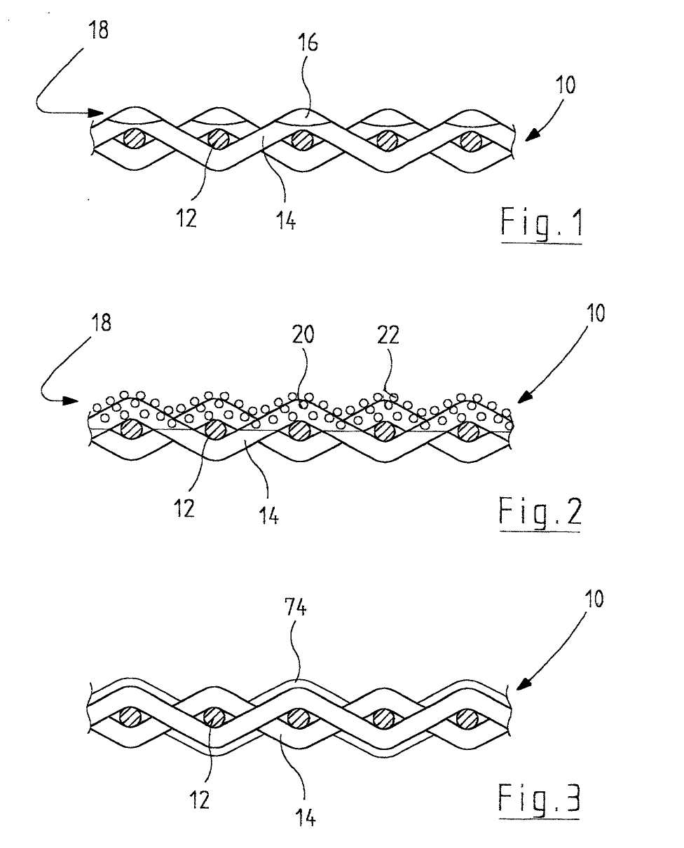

FIG. 1 shows an enlarged section through a woven fabric which is provided at the cross-over points between the warp and weft threads with caps made out of a functional material;

FIG. 2 shows a view similar to FIG. 1, in which the one side of the textile base structure is coated continuously with particles;

FIG. 3 shows a view similar to FIG. 1, there being spaced amongst the warp and weft threads those which project beyond the surface of the fabric and are manufactured from a particular material;

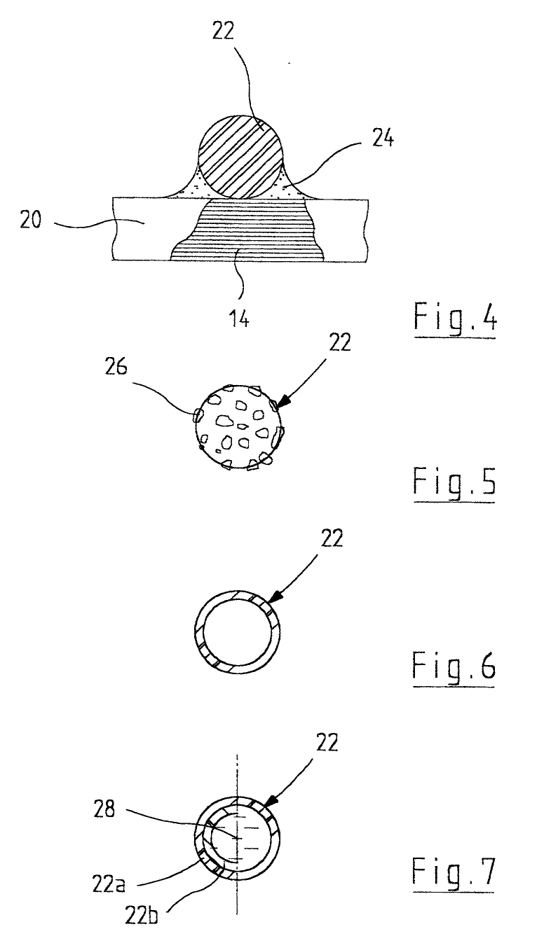

FIG. 4 shows an enlarged detail, in which the connecting points between a spherical particle of the fabric coating and a fibre of the fabric is illustrated in more detail;

FIG. 5 shows a view of a modified coating particle;

FIG. 6 shows a section through a further modified coating particle;

FIG. 7 shows a section through a coating particle which contains an active-substance liquid.

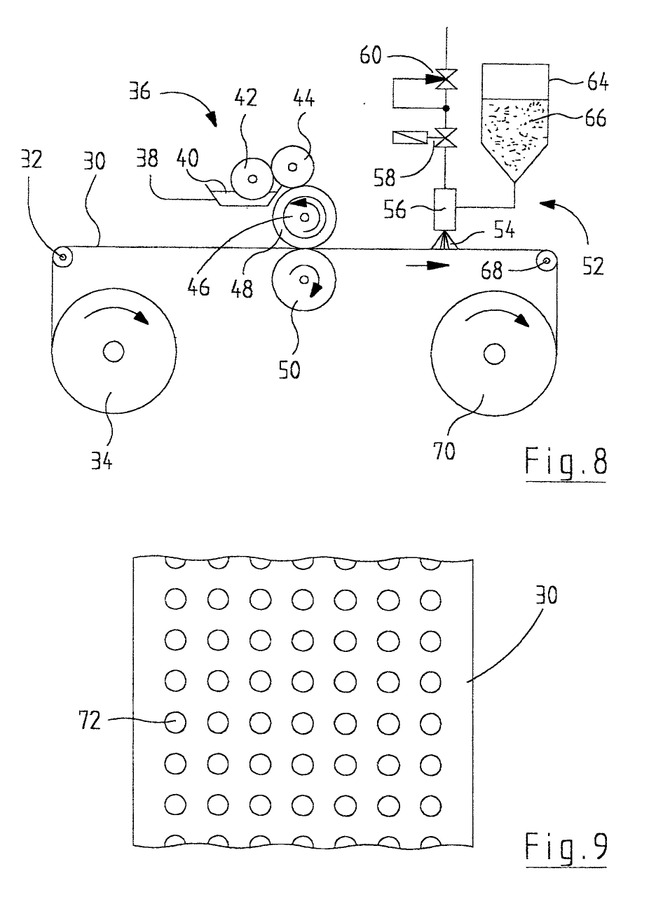

FIG. 8 shows a schematic view of an arrangement for coating a textile base structure;

FIG. 9 shows a plan view of a coated textile web; and

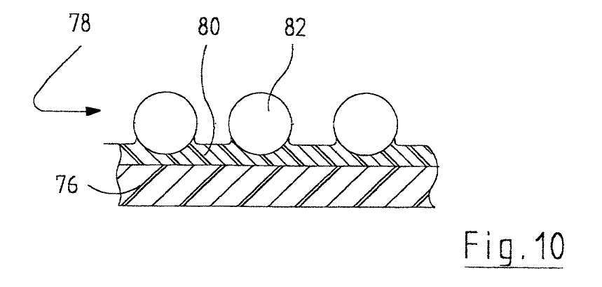

FIG. 10 shows a section through textile material which has a film base-structure.

FIG. 1 shows a woven fabric which is denoted as a whole by 10 and has warp threads 12 and weft threads 14.

On the regions which lie above the warp threads 12, the weft threads 14 are provided with caps 16 made out of a functional material. This can be effected for example in that the functional material is applied in a liquid condition to a hard application roller and is rolled onto the one side of the fabric 10 by means of this roller.

The caps 16 are preferably manufactured from a material which can glide over the human skin with a low degree of friction. Such a material is for example polyamide or silicone rubber. The liquid material, which is applied to the fabric 10, can be in the form of a dispersion which has pigment bodies distributed very finely in a suitable carrier liquid (water or an aqueous bonding agent) and have the desired properties. Alternatively, it is also possible to use a solution of the material in volatile solvents.

In the case of the fabric illustrated in FIG. 1, the caps 16, which lie substantially in a plane above the plane of the fabric, form a functional layer which is denoted as a whole by 18. A wearer's skin comes into contact with this functional layer. The properties of the fabric in those regions of the fabric 10 which do not come into contact with the wearer's skin are unaltered.

It goes without saying that, in a modification of the exemplary embodiment according to FIG. 1, it is also possible to provide the underside of the fabric with caps 16. The fabric can then be worn on either side.

In the modified exemplary embodiment according to FIG. 2, those portions of the weft threads and warp threads which lie above the central plane of the fabric are provided with a bonding-agent layer 20, by way of which a plurality of small spherical particles 22 are connected to the threads of the fabric. In this exemplary embodiment, the bonding-agent layer 20 and the particles 22 form the functional layer 18. At least the material of the particles 22, and preferably also that of the bonding-agent layer 20, is selected such that it glides over a wearer's skin with a low degree of friction and/or has a pleasant feel.

The particles 22 can be solid particles, as illustrated in FIG. 4. A suitable material for solid particles 22 is for example silicone rubber. The individual particles are connected to the threads of the fabric by way of menisci 24 of the bonding-agent layer 20, which form at the contact points between the particles 22 and the warp threads 12 and weft threads 14.

In the exemplary embodiment according to FIG. 5, active-substance particles 26, whereof the diameter is smaller than the diameter of the particles 22, are embedded in the particles 22. The active-substance particles can be those whereof the material ensures a low degree of friction against a wearer's skin, or those which contain care substances or chemical or medicated active substances, or even those which contain fragrances. The active-substance particles 26 can also be a mixture of different types of the active-substance particles mentioned above.

In the exemplary embodiment according to FIG. 5, the active-substance particles 26 are only provided near to the surface of the spherical particles 22. If it is to be expected that the particles 22 will deteriorate when the fabric is worn, the active-substance particles 26 are also distributed within the volume of the particles 22, so that upon deterioration of the deterioration of the particles 22 new active-substance particles 26 are repeatedly exposed each time.

FIG. 6 illustrates particles 22 which are hollow. These particles can be manufactured from the same material as the solid particles 22 illustrated in FIG. 4. However, the fact that the particles are hollow results in a saving on material and a reduction in weight. Moreover, as a result of their geometry, the individual particles 22 have a greater deformability than the solid particles.

According to FIG. 7, hollow particles can also be filled with an active-substance liquid 28, the active-substance liquid 28 can include for example fragrances, perspiration-reducing or perspiration-decomposing active substances or care substances such as oils or medicated active substances. The wall of the particles 22 is constructed such that it is partially permeable to the active-substance liquid 28 or the active substances contained therein, so that the active substances are released over a long period of time.

The wall material of the particles illustrated in FIG. 7 is preferably selected such that the permeability to the active substances increases with a rise in temperature. This then ensures that the active substances are only released when the fabric is warmed by a wearer's skin, whilst at room temperature, i.e. when the fabric is not being worn, the active substances are no longer released or are released to a lesser extent.

In order to be able to adjust the long-term characteristics relating to the release of the active substances in a further region, some of the microcapsules can be constructed in the manner illustrated in the left half of FIG. 7: The wall of the particles 22 comprises two layers 22a and 22b, which differ in terms of their resistance to the environmental parameters encountered under wearing conditions. The other particles 22 include only the wall layer 22a, as illustrated in the right-hand part of FIG. 7.

For coating the inside of a jeans material (cotton body), double-walled microcapsules are preferably constructed as follows: Inside there is an oily extract of aloe vera. This extract is surrounded by an inner capsule wall 22b of polyethylene. This latter is surrounded by an outer capsule wall 22a of silicone elastomer. This latter contains approximately 5 wt. % of plasticiser and approximately 2 wt. % of thickener. In a last manufacturing step, the capsules are dried at 160° C. for 90 seconds.

The microcapsules obtained in this way are distributed in a silicone-elastomer bonding agent (preferably the same elastomer as that which is also used for the capsule wall 22a), and the mixture obtained in this way is sprayed onto the surface of the material. The coating is then dried with hot air.

The fabric thus attains a soft, cream-like feel. The microcapsule coating is wash-proof. The liberation of aloe vera is effected as a result of mechanical destruction of the capsule wall (caused by pressure or deterioration when the material is worn).

The particles 22 have a diameter of between 2 μm and 2,000 μm, preferably between 2 μm and 100 μm, and preferably between 2 μm and 10 μm.

Here, the larger particle diameters are used for coarser fabrics, and the smaller particle diameters are used for fine fabrics.

Materials which are particularly suitable for the wall material of the particles 22 are selected from the following group of materials: ceramics materials, silicone elastomers, polyurethanes, nitrile rubbers, chloroprene rubbers, polyvinyl alcohols, silicones, ethylene/vinyl-acetate polymers, acrylic resins.

A functional layer 18 which contains ceramics particles 22 (diameter preferably approximately 5 μm) feels cool when worn.

It goes without saying that, in a modification of the particles 22 which are illustrated in FIGS. 6 and 7, it is also possible to provide additional active-substance particles 26, as illustrated in FIG. 5.

In a further modification of the exemplary embodiments described above, combinations of the particles described above can be used as the particles 22.

If the particles are microcapsules which contain an active substance, it is possible to set the long-term release of the active substance through the particles in terms of its time dependency by selecting different resistances of the wall material to environmental influences such as mechanical action (pressure), temperature and moisture. The release rate can also be controlled via the thickness of the wall material. Finally, a further parameter which makes it possible to determine whether the contents of the capsule are released quickly or slowly, is the diameter of the particles.

FIG. 8 shows a schematic view of an arrangement for creating a functional layer 18 on a fabric 10.

A fabric web 30 is drawn from a supply reel 34 by way of an idle roller 32 and guided through an application unit 36. The application unit includes a supply vessel 38 for a liquid bonding agent 40. A lifting roller 42 dips into the supply vessel 38 and delivers liquid to the circumferential surface of an application roller 46 by way of a transfer roller 44. The application roller 46 has an outer circumferential layer 48 which is manufactured from an elastomeric, preferably porous, material.

Provided below the application roller 46, there is a mating roller 50 which has a hard, smooth outer surface. The application roller 46 and mating roller 50 are driven in counter-rotation, as indicated by arrows, so that the fabric web 30 runs through the application unit 36 in the direction indicated by an arrow.

Provided downstream of the application unit 36, there is a powdering unit 52 which directs a mist 54 of particles 22 against the upper side of the fabric. The powdering unit 52 has a mixing chamber 56 whereof the exit opening is directed towards the upper side of the fabric and which is acted upon by compressed air by way of a solenoid valve 58 and a pressure regulator 60, the compressed air being provided from a compressed-air line 62.

A second entry of the mixing chamber 56, which can operate for example according to the water-jet principle, is connected to the outlet of a supply container 64 in which there is a supply of particles to be dusted on.

Downstream of the powdering unit 52, the fabric web 30 runs over a further idle roller 68 and is wound onto a take-up reel 70.

Thus, the arrangement which is described above and illustrated in FIG. 8 first of all provides the upper side of the fabric with a bonding-agent layer, and the particles 22 are then dusted onto this latter.

In one modification, the powdering unit 52 can also be omitted and the particles 22 can already be admixed to the liquid bonding agent located in the supply container 38, or this latter can be filled with a coating material instead of the bonding agent, which ensures the desired feel and a good gliding action over the skin.

In a further modification, the application roller 46 can be constructed as a rotary screen-printing roller. If a screen having permeable regions arranged in the pattern of a quadratic grid is used on such a screen-printing roller, a fabric web 30 is produced which is only provided with a functional layer in the permeable regions of the screen-printing drum. The corresponding circular sub-regions of the fabric web 30 are denoted by 72 in FIG. 9. The coating mass is then preferably applied such that it is thick enough for the coated side of the fabric to only come into contact with the skin by way of the patch-shaped sub-regions 72, whilst the uncoated intermediate fabric regions are held slightly away from the surface of the skin.

FIG. 3 illustrates a woven fabric, which can also glide over a wearer's skin with a low degree of friction. Every tenth weft thread 14, for example, is replaced by a weft thread 74 which has a greater diameter than the weft threads 14 and is manufactured from a material which glides over the skin with a low degree of friction. This can be for example a polyamide thread or another suitable plastics thread.

Although the fabric according to FIG. 3 also ensures that the contact between the fabric and the wearer's skin is effected by way of a low-friction material, it is clear that the basic properties of the fabric, and in particular the air-permeability of the fabric, continue to be provided by the material of the warp threads 12 and the weft threads 14. The invention was explained above with reference to a woven fabric. It can, however, be used equally for textile materials such as thread composites, knitted fabrics or fleeces.

Films can also be used as the starting material for some items of clothing. Here, it is again desirable for the material to lie pleasantly against the skin.

FIG. 10 shows a film 76 which is manufactured from a material suitable for items of clothing. A functional layer 78 is applied to one side of the film, for example using a squeegee or roller, or by pressing it on. This functional layer comprises a bonding agent 80 and particles 82 which are incorporated in this latter. These particles can be of a similar construction to the particles 22, which were described above with reference to FIGS. 2 to 7.

As in the other exemplary embodiments, a coating on both sides is also analogously possible here.

1. A textile material having a base structure (10) comprising fibres (12, 14) or a film base-structure (76), characterised in that the base structure (10; 76) supports a functional layer (18; 78) on at least one of its sides.

2. A textile material according to claim 1, characterised in that the functional layer (18) has spaced sub-regions (72).

3. A textile material according to claim 1 or 2, characterised in that the functional layer (18; 78) preferably comprises spherical particles (22; 82).

4. A textile material according to claim 3, characterised in that the particles (22) are solid.

5. A textile material according to claim 3 or 4, characterised in that the particles (22) include at least one embedded active substance (26).

6. A textile material according to claim 5, characterised in that the active substance (26) is provided near to the surface of the particles (22).

7. A textile material according to one of claims 3 to 6, characterised in that the particles (22) are hollow.

8. A textile material according to claim 7, characterised in that an active-substance fluid (28) is arranged inside at least some of the hollow particles (22).

9. A textile material according to claim 8, characterised in that the particles (22) are microcapsules.

10. A textile material according to claim 8 or 9, characterised in that amongst the particles (22) there are those whereof the wall material differs in terms of its resistance to environmental influences, in particular pressure, moisture and temperature.

11. A textile material according to one of claims 8 to 10, characterised in that amongst the particles (22) there are those which differ in terms of the thickness of their wall material.

12. A textile material according to one of claims 8 to 11, characterised in that amongst the particles (22) there are those which have a wall having at least two layers (22a, 22b) which differ in terms of their resistance to environmental parameters.

13. A textile material according to one of claims 8 to 12, characterised in that amongst the particles (22) there are those which differ in terms of their diameter.

14. A textile material according to one of claims 3 to 13, characterised in that the particles (22; 82) are connected to the base structure (10; 76) by a bonding agent (20; 80).

15. A textile material according to one of claims 3 to 13, characterised in that the particles (22) are applied to the base structure (10; 76) when their outer surface is in an adhesive condition.

16. A textile material according to one of claims 1 to 15, characterised in that the functional layer (18) has spaced fibres (74), which are incorporated in the base structure (10) such that they project beyond the surface thereof on at least one side.

17. A textile material according to one of claims 1 to 16, characterised in that the functional layer (18; 78) has a material which glides over skin with a low degree of friction.

18. A textile material according to one of claims 3 to 17, characterised in that amongst the particles (22) there are those which are selected from the following group of materials: ceramics materials, silicone elastomers, polyurethanes, nitrile rubbers, chloroprene rubbers, polyvinyl alcohols, silicones, ethylene/vinyl-acetate polymers, acrylic resins.

19. A textile material according to one of claims 3 to 18, characterised in that the particles (22) have a diameter of between 2 μm and 2,000 μm, preferably between 2 μm and 100 μm, and preferably between 2 μm and 10 μm.

20. A textile material according to one of claims 1 to 19, characterised in that the functional layer (18; 78) may be dissolved by water and/or a solvent.

21. A process for manufacturing a textile material according to one of claims 1 to 20, characterised in that at least part of the functional layer (18; 78) is applied to the base structure (10; 76) in a liquid condition using an application roller (46).

22. A process according to claim 21, characterised in that an application roller (46) is used which has a compliant circumferential layer (48).

23. A process according to claim 21, characterised in that a circumferential layer (48) is used which has a foam structure.

24. A process according to claim 21, characterised in that an application roller (46) is used which is constructed as a rotary screen-printing roller.

25. A process for manufacturing a textile material according to one of claims 3 to 20, characterised in that at least some of the particles (22; 78) are mixed with carrier air in an mixing device (56), and the particle/air mixture (54) obtained in this way is blown against the base structure (10; 76).

26. A process for manufacturing a textile material according to one of claims 3 to 20, characterised in that at least some of the particles (22; 78) are mixed with a bonding agent, and the particle/bonding-agent mixture obtained in this way is sprayed against the base structure (10; 76).
